(19) United States
(12) Patent Application Publication
(10) Pub. No.: US 2006/0179138 A1
(43) Pub. Date: Aug. 10, 2006

(54) User-specific interaction with content sotred on upnp network

(75) Inventors: Josef Pieter Van Gassel, Eindhoven (NL); Hendrikus Bernardus Van Den Brink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/561,857

(22) PCT Filed: Jun. 21, 2004
(86) PCT No.: PCT/IB04/50946

§ 371 Date: Dec. 21, 2005

(30) Foreign Application Priority Data
Jun. 25, 2003 (EP) 03101863.3

(51) Int. Cl. G06F 15/173

(52) U.S. Cl. 709/225

(57) ABSTRACT

On a UPnP AV network, different users are identified based on respective IP addresses in the SOAP requests for interaction with AV content stored on the network's MediaServers. Under control of the identity thus determined, the relevant MediaServer generates personalized views of the available content, possibly re-organizing content items in the inventory overview or blocking items from being viewed by specific users on the network.

### FIELD OF THE INVENTION

The invention relates to a multi-user network, in particular to a network based on a UPnP software architecture, that stores an inventory of content information such as audio/video (ANV) content items and computer games, that is accessible to multiple users.

### BACKGROUND ART

Universal Plug and Play (UPnP) is an industry-wide ongoing development for an open network architecture that is designed to enable simple, ad hoc communication among distributed devices and software applications from multiple vendors. UPnP leverages Internet technology and extends it for use in non-supervised home networks. UPnP aims at controlling home appliances, including home automation, audio/video, printers, smart phones, etc. UPnP distinguishes between Control Points (CPs) and controlled devices (CDs). CPs comprise, e.g., browsers running on PCs, wireless pads, etc., that enable a user to access the functionality provided by controlled devices.

UPnP defines protocols for discovery and control of devices by CPs. UPnP does not define a streaming mechanism for use by AudioVideo devices. Some of the discovery and control protocols are part of the UPnP specification while others are separately standardized by the IETF (Internet Engineering Taks Force).

Interaction between CPs and devices is based on the Internet protocol (IP). However, UPnP allows non-IP devices to be proxied by a software component running on IP-compliant devices. Such a component, called Controlled Device (CD) proxy, is responsible for translation and forwarding of UPnP interactions to the proxied device.

A UPnP device has a hierarchy of sub-devices with at the lowest level services. Both devices and services have standardized types. A device type determines the sub-devices or services that it is allowed to contain. A service type defines actions and state variables that a service is allowed to contain. State variables model the state of the device, actions can be invoked by a CP in order to change that state. The description of the state variables and the actions is called the SCP (Service Control Protocol). A UPnP device provides a description of itself in the form of an XML document. This document contains, among other things, the service types that it supports. Optionally, a device may have a presentation server for direct UI control by a CP.

UPnP relies currently on AutoIP, which provides a means for an IP device to get a unique address in the absence of a DHCP server. UPnP defines a discovery protocol, based on UDP multicast, called SSDP (Simple Service Discovery Protocol). SSDP is based on devices periodically multicasting announcements of the services that they provide. An announcement contains a URL to which service actions are to be sent: the control server. In addition to that, CPs may query the UPnP network for particular device or services types or instances.

UPnP relies on GENA (Generic Event Notification Architecture) to define a state variable subscription and change notification mechanism based on TCP.

After a CP has detected a service it wants to use (via SSDP), it controls the service by sending SCP actions to the control server URL or querying for state variables. Actions are sent using HTTP POST messages. The body of such a message is defined by the SOAP (Simple Object Access Protocol) standard. SOAP defines a remote procedure call mechanism based on XML.

The UPnP AV (audio/video) specification relates to interaction between UPnP AV devices, e.g., TV sets, video recorders, DVD players, settop boxes (STBs), PCs, etc., and the associated CPs. The UPnP AV specification defines a MediaServer device and MediaRenderer device and their services. A MediaServer (MS) on the network stores AV content and exposes it to other devices on the network. Content items are stored in a hierarchical view, similar to file folders in an electronic filing system on a PC, for example. A MediaRenderer (MR) on the network plays back the AV content stored at the MSs.

### SUMMARY OF THE INVENTION

The home network typically has multiple users. The users may share some or all of the content on the network, and they may have different preferences with regard to organizing the content items. For example, a first user wants to have the audio file collection organized according to artists, a second user wants to organize the same collection according to title of the item, etc. Further, not all content items may be of interest to each user. Especially if the content collection is large, browsing the collection might be facilitated if the system were to pre-select those categories and items that are relevant or of interest to the particular user. In addition, privacy or parental control may be issues if there are content items on the network, which are not intended or not suitable for being accessed by other users. However, UPnP AV does not provide ways to authenticate different users. Therefore, the inventors propose to provide personalization, conditional access and security options on a UPnP network in order to overcome aforesaid limitation, preferably without affecting the UPnP middleware layer, without causing conflicts with the UPnP spec., and without making vendor-specific additions.

To this end, an embodiment of the invention relates to a method of enabling multiple users of a UPnP network to access an inventory of content information items stored at a MS on the network. The method comprises enabling to identify each respective one of the multiple users by means of a respective one of different addresses, contained in a respective request, e.g., a respective IP-based SOAP request, for access to the MS, and enabling to provide respective modes of access to the inventory that are different for the respective addresses. In an embodiment of the invention, the respective modes of access differ from one another with regard to a right to access at least a specific one of the content information items. For example, one or more items as presented in a graphical representation of the inventory are accessible to only a specific user or a group of specific users as identified by their addresses. In another embodiment, the respective modes differ from one another with regard to the representation of the inventory, graphical or otherwise. For example, all users but a specific one are blocked from viewing particular items listed in a representation of the inventory, e.g., in a browse or search operation. As another example, different users are presented different views of the inventory, e.g., based on the users' individual preferences such as ranking or organizing of the items in the inventory according to title or to performer, or according to date and time of the item when first added to the inventory, or to another criterion. Again, different users are identified based on their respective addresses so as to be able to personalize the representation of the inventory. In another embodiment, the respective modes of access differ from one another with regard to user interaction allowed with respect to at least a specific one of the content information items. For example, a particular user is allowed to access and render some items, but not to copy, update or edit these items. As another example, some users are allowed to access some items only in a particular time slot, and other users in another time slot. This option can be relevant to, e.g., a parental control of movies or other audio/video content. For example, some movies are simply blocked from the children's view, and others are only accessible in particular time slots because of home work or other educative or social duties.

In case all users have individual CPs, IP-addresses or MAC-addresses can be used to identify each respective one of the users and the associated access privileges. If, on the other hand, the users share CPs in operational use, authentication procedure software installed at the CP generates an IP-address per user, e.g., upon a password log-in or fingerprint detection. Alternatively, the CP uses multi-homing in order to work with multiple addresses on the same network, each respective address assigned to a respective user. Multi-homing refers to the ability to have a network-enabled device use multiple addresses on the same physical network.

A unique ID may also be embedded as an XML tag in the actual SOAP message. In SOAP, arbitrary tags can be added to a message if an “any” element is present. An application that does not know the tag will just skip it. If, however, the “mustUnderstand” attribute has been set to “true” and the application does not know the tag, the message gets refused. UPnP version 1.0 uses SOAP version 0.9 that is ambiguous about adding tags. Future versions of the UPnP standard, e.g., UPnP 2.0 and UPnP 1.1, will be using SOAP 1.1 that explicitly allows for such a scheme.

The MS, or another device on the network to which the user identification has been delegated, maintains a list of users and/or their associated addresses. The MS then generates different views of the object hierarchy for different users. The personalized views are specified by the user, i.e. the end-user associated with a particular personalized view, or by a special user with administrator rights. Alternatively, the MS can create views in an automated way using special rules to create default views, e.g. based on preferences, context or content type. The devices on the UPnP network see only a single MS advertising itself during the discovery phase, but the MS exposes different views to different users when responding with different results to requests issued by different users. In this manner, content that is not intended or suitable for some users is not exposed and, hence, cannot be browsed, searched, retrieved, deleted, edited, updated, rendered, etc., by these network users. CPs whose IP-addresses are unknown can be given access in a pre-determined default mode, e.g., only viewing and rendering access capabilities with regard to content shared by all users. Note that it is also possible to create group views, e.g. for content shared by multiple users, with this shared content. Accordingly, what has been explained above with regard to differentiating between individual users based on their respective addresses can also be applied to differentiating between groups of users. A group then comprises one or more users, each with a respective address. The addresses per group are associated with a single mode of access.

Another embodiment of the invention relates to software for use on a UPnP network with a MediaServer that stores an inventory of content information items. The software controls user access to the inventory. The software provides or enables to provide different modes of access that are different for respective users as identified by respective addresses, e.g., IP addresses or MAC addresses, in respective requests for access to the inventory. The software provides the respective modes of access that differ from one another with regard to the access to at least a specific one of the content information items. Alternatively, or in addition, the software provides the respective modes of access that differ from one another with regard to user interaction allowed with at least a specific one of the content information items. Preferably, the modes of access are programmable (again, by the end-user associated with the particular content items or by a special user having administrator rights) when installed on the UPnP network. In this manner, an existing UPnP network can be upgraded to accommodating multiple users and to providing personal interaction modes.

### BRIEF DESCRIPTION OF THE DRAWING

The invention is explained in further detail, by way of example and with reference to the accompanying drawing wherein:

FIG. 1 is a block diagram of a UPnP network; and

FIG. 2 is a diagram illustrating the user interaction process.

Throughout the figures, same reference numerals indicate similar or corresponding features.

### DETAILED EMBODIMENTS

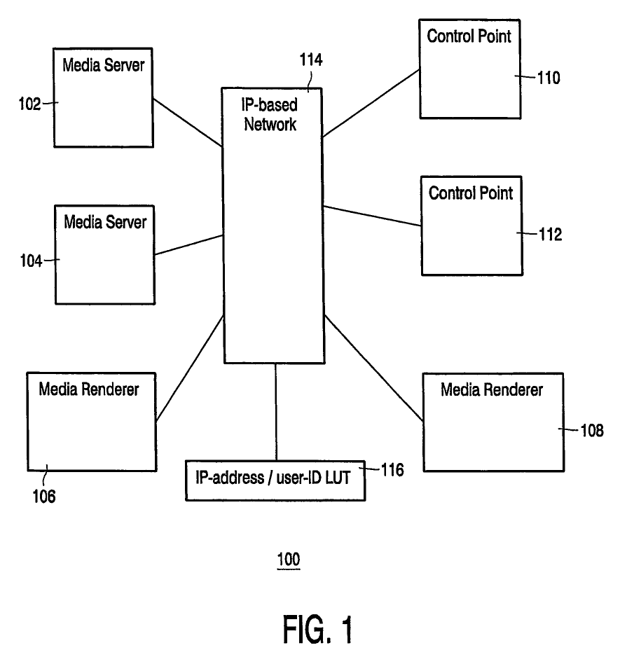

FIG. 1 is a block diagram of a UPnP home network 100 in the invention.

Network 100 comprises MSs 102,104; MRs 106, 108; and CPs 110 and 112 that communicate via an IP-based network 114. MSs 102-104 store content information and supply it to one or more of MRs 106-108 that render the content information. CPs 110-112 serve to provide a user interface to network 100 in order to control, e.g., at which one of MSs 102-104 to store a newly acquired content item, browsing and searching of content available on network 100; at which one of MRs 106-108 to play out a content item selected from the inventory of content at a specific one of MSs 102-104, etc. Note that the classification into MSs, MRs and CPs refers to functionalities, rather than to physical entities.

MSs 102-104 are interacted with by multiple users. These users may share part of the content stored. However, different users may have different preferences with regard to organizing the content, and not all users have access to each content item. In a UPnP environment, as on home network 100, content items are stored in a hierarchical view, similar to folders in an electronic file system. As to this hierarchical view, the UPnP AV Content Directory service enumerates content available through the associated MS device. The Content Directory service exposes a class hierarchy, which is used to identify all objects that can be retrieved from it. Each class is named using a string with a pre-defined syntax. Each class definition includes a list of properties. Some properties are required while others are optional. Some properties are “multi-valued” for a class, meaning that, in an XML instance of the class, the property may occur more than once. A class that is derived from another class must include all the required properties of the base class. The definition of a subclass may make some optional properties of the base class required. Each property will be expressed in XML as either an XML Element or XML Attribute. Note that these could also include information on the access rights to generate the personalized views.

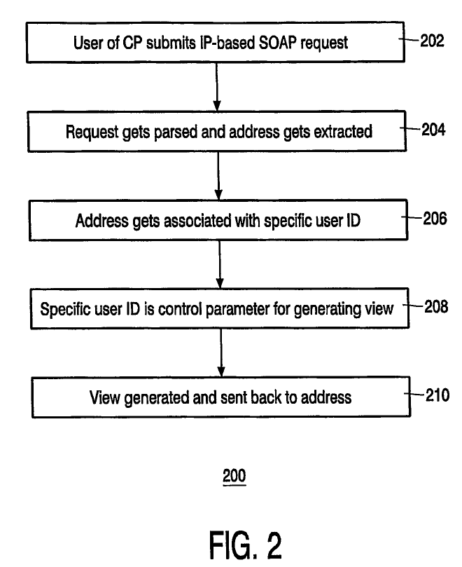

FIG. 2 is a diagram illustrating an example of a process 200 of user interaction. Assume that CP 110 submits in a step 202 a SOAP request to browse the content inventory of, e.g., MS 102. Depending on the implementation of the CP's software the user is to explicitly specify the MS to be accessed, or the software translates the user's request into an access command to a specific MS. In a step 204, the IP packet containing the SOAP request gets parsed and the address (IP or MAC) of CP 110 gets extracted. In a step 206, the address thus acquired gets associated with a specific one of multiple users, e.g., according to a pre-determined look-up table. In case CP 110 is a personal device or functionality, the IP address or MAC address is a unique identifier of the specific user. If on the other hand, e.g., CP 110 is being used by multiple users, different IP addresses are to be generated, one for each user interacting through CP 110. In that case multi-homing can be employed. Alternatively, an authentication process at CP 110 is to generate a new IP address based on who has been identified by the authentication process. The authentication process may use, e.g., log-in passwords or biometrics (e.g., fingerprint detection, etc.). The hardware network interface of CP 108 then uses multiple IP addresses, each of the users then being assigned a fixed and personal IP address. Alternatively, the device changes its IP address to the address assigned to the person that is currently authenticated by the device (assuming only one user can be authenticated at a time).

The process of associating a specific user or user identifier (user ID) with a specific IP address is carried out by, e.g., CP 110, or MS 102 or another component, e.g., a device 116 on network 100 to which this task has been delegated. Based on successful user identification, MS 102 generates a view of the content available. Different users may require different views. In a step 208, MS 102 uses the user ID found to correspond with the address determined in step 204, in order to generate a user-dependent view of the content available at MS 102. Then, in a step 210, MS 102 sends back to the address data that enable to create this view at CP 110. This view may have the format of, e.g., an interactive web page or a graphical representation of a file folder system as at a PC to be presented at a GUI of CP 110. For example, the user can click on items via a touch screen to select them. Above interactions have been illustrated with regard to a browse request, but are also applicable to searching, adding, editing, updating, etc., of content items.

On a UPnP level, the browse and search results are sent in DIDL-Lite XML fragments as specified in the specification. In order to keep track of the rights of users with respect to specific content items, an administration is maintained that either lists the users with their access rights per content item, or lists the content with the rights per user. The owner, e.g., the creator of the item or the administrator maintains these lists of access rights in a database. This information can possibly be mixed with the DIDL-Lite meta-data database. This could be taken care of by using a special UI or a remote application running on a different device for convenience, e.g., a PC. The owner or administrator can change the rights per user or per content item. In cases where the MS automatically creates content, e.g., from recording, special rules could be applied to determine (default) rights upon creation.

In case of group views the database also needs to keep track of which users belong to a specific group and what the rights of these groups are (in order to create the group views). These group views can be specific parts in a personalized view.

Incorporated by reference herein:

U.S. Ser. No. 09/635,548 (attorney docket US 000185) filed Jul. 25, 2000 for Jean Moonen for UI-BASED HOME NETWORK BRIDGING, and published under PCT as WO0209384. This document relates to a home network comprising a UPnP cluster and a HAVi cluster. UPnP uses programmatic device interfaces that are based on standardized messages being sent between the devices. HAVi also uses programmatic interfaces but needs to know the proper device type and FCMs in advance. In addition, the current UPnP and HAVi standards do not define devices that can readily be mapped onto one another owing to semantic differences. To overcome this problem, the clusters are bridged by representing a UPnP device on the HAVi cluster, wherein the UPnP device's description document is used to generate a HAVi DDI target to enable UI-based control of UPnP devices through a HAVi UI.

U.S. Ser. No. 09/616,632 (attorney docket US 000184) filed Jul. 26, 2000 for Jean Moonen and Eugene Shteyn for SERVER-BASED MULTI-STANDARD HOME NETWORK BRIDGING, and published under PCT as WO0209350. This document relates to a bridge in a home network that couples first and second clusters of devices. The clusters have different software architectures. The bridge is connected to a server on the Internet. This server offers a lookup service for some set of standards, and allows a bridge to locate and download the appropriate translation modules for allowing a device in the first cluster to interact with the second cluster.

U.S. Ser. No. 09/568,932 (attorney docket US 000106) filed May 11, 2000 for Eugene Shteyn and Ruud Roth for ELECTRONIC CONTENT GUIDE RENDERS CONTENT RESOURCES TRANSPARENT, published under PCT as WO0186948. This document relates to a data management system on a home network. The system collects data that is descriptive of content information available at various resources on the network. The data is combined in a single menu to enable the user to select from among the content, regardless of the resource.

1. A method of enabling multiple users of a UPnP network to access an inventory of content information items stored at a MediaServer on the network, the method comprising:
enabling to identify each respective one of the multiple users by means of a respective one of different addresses contained in a respective request for access to the MediaServer; and
enabling to provide respective modes of access to the inventory that are different for the respective addresses.

2. The method of claim 1, wherein the respective modes of access differ from one another with regard to rights to access at least a specific one of the content information items in the inventory.

3. The method of claim 1, wherein the respective modes of access differ from one another with regard to user interaction allowed with at least a specific one of the content information items in the inventory.

4. The method of claim 1, wherein the respective modes of access differ from one another with regard to a representation of the inventory.

5. The method of claim 1, wherein the respective addresses comprise respective IP addresses or respective MAC addresses of respective Control Points on the network.

6. The method of claim 5, wherein the respective addresses are comprised in respective SOAP requests to the MediaServer.

7. The method of claim 1, wherein the network comprises a Control Point that enables the multiple users to interact with the network, the method comprising enabling the Control Point to use different addresses for respective ones of the multiple users.

8. For use on a UPnP network with a MediaServer for storing an inventory of content information items, software for control of user access to the inventory, wherein the software provides different modes of access that are different for respective users as identified by respective addresses in respective requests for access to the inventory.

9. The software of claim 8, wherein the respective modes of access differ from one another with regard to rights to access at least a specific one of the content information items in the inventory.

10. The software of claim 8, wherein the respective modes of access differ from one another with regard to user interaction allowed with at least a specific one of the content information items in the inventory.

11. The software of claim 8, wherein the respective modes of access differ from one another with regard to a representation of the inventory.

12. The software of claim 8, wherein the modes of access are programmable.
